(19) United States
(12) Patent Application Publication
(10) Pub. No.: US 2016/0306211 A1
(43) Pub. Date: Oct. 20, 2016

(54) LIQUID CRYSTAL DISPLAY PANEL AND FABRICATION METHOD OF THE SAME

(71) Applicant: Samsung Display Co., LTD., Yongin-si (KR)

(72) Inventor: Chang-hun LEE, Hwaseong-si (KR)

(21) Appl. No.: 15/047,044

(22) Filed: Feb. 18, 2016

(30) Foreign Application Priority Data
Apr. 14, 2015 (KR) 10-2015-0052666

(51) Int. Cl. G02F 1/1343; G02F 1/1335; G02F 1/1341

(52) U.S. Cl. CPC G02F 1/13439; G02F 1/1341; G02F 1/133512; G02F 1/133514; G02F 1/133516; G02F 1/134309

(57) ABSTRACT

A manufacturing a first substrate of a display panel include providing a control terminal electrode and a common electrode line on a first insulation plate, providing a common electrode to contact with the common electrode line and providing a semiconductor pattern to overlap the control terminal electrode, providing an input terminal electrode to contact with a portion of the semiconductor pattern and providing an output terminal electrode to contact with another portion of the semiconductor pattern and to be spaced apart from the input terminal electrode, determining an orientation angle of a slit of a pixel electrode to substantially match a rising time and a falling time of a liquid-crystal applying signal with each other based on a simulation result, and providing the pixel electrode, which includes a plurality of slits having the determined orientation angle, to contact with the output terminal electrode.

This application claims priority to Korean Patent Application No. 10-2015-0052666 filed on Apr. 14, 2015, and all the benefits accruing therefrom under 35 U.S.C. §119, the content of which in its entirety is herein incorporated by reference

### BACKGROUND

Embodiments of the inventive concepts described herein relate to a liquid crystal display panel and a fabrication method of the liquid crystal display panel, and more particularly, relate to a positive type (“P-type”) liquid crystal display panel for preventing a flickering effect and a fabrication method of the P-type liquid crystal display panel.

A liquid crystal display device is one of the most widely used types of flat-panel display in electronic apparatuses. A liquid crystal display device generally includes two substrates and a liquid crystal layer interposed between the two substrates, in which an electric field is generated to the liquid crystal layer, and liquid crystal molecules of the liquid crystal layer are thereby rearranged to adjust a quantity of light that is transmitted through the liquid crystal layer.

Such liquid crystal display devices may be classified as one of a vertical electric-field mode or a horizontal electric-field mode.

### SUMMARY

In recent years, as a vertical electric-field liquid crystal display device that operates in the vertical electric-field mode are found difficult to improve viewing angle, many researches and developments have been sprightly going to improve the horizontal electric-field liquid crystal display devices. Especially, plane-to-line switching (“PLS”) liquid crystal display devices, which operate in the horizontal electric-field mode, are currently interested on the study for reducing product costs thereof

Embodiments of the inventive concept is directed to a fabrication method of a positive type (“P-type”) liquid crystal display panel capable of preventing a flickering effect even while the panel is operating in a low frequency.

In an embodiment, a fabrication method of a display panel may include: manufacturing a first substrate of the display panel: providing a second substrate of the display panel to face the first substrate: and combining the second substrate with the first substrate and providing a liquid crystal layer between the first and second substrates by injecting liquid crystals between the first and second substrates. In such an embodiment, the manufacturing the first substrate includes: providing a first insulation plate; providing a control terminal electrode and a common electrode line on the first insulation plate; providing a common electrode to contact with the common electrode line and providing a semiconductor pattern on the control terminal electrode to overlap each other when viewed from a top view; providing an input terminal electrode to contact with a part of the semiconductor pattern and providing an output terminal electrode to contact with another part of the semiconductor pattern and to be spaced apart from the input terminal electrode; determining an orientation angle of a slit to be defined in a pixel electrode to substantially match a rising time and a falling time of a liquid-crystal applying signal corresponding to an electric field to be applied to the liquid crystal layer, with each other; and providing the pixel electrode, in which a plurality of slits having the determined orientation angle is defined, to contact with the output terminal electrode.

In an embodiment, the liquid crystal may be a positive-type (“P-type”) liquid crystal.

In an embodiment, the providing the pixel electrode may include providing the pixel electrode to be at least partially overlap the common electrode when viewed from the top view.

In an embodiment, the second substrate may include a second insulation plate, a black matrix disposed on the second insulation substrate, and color filters correspondingly disposed in respective areas of the second insulation substrate, which are defined by the black matrix.

In an embodiment, the orientation angle may be defined as an angle formed between an imaginary line, which intersects the center of a pixel of the display panel when viewed from the top plan view, and each of the slits.

In an embodiment, the orientation angle of the slit may be in a range of about 10° to about 15°.

In an embodiment, the rising time may be defined as a time period from a time point of a voltage level rising point of the liquid-crystal applying signal to a time point of the highest voltage level point of the liquid-crystal applying signal, and the falling time may be defined as a time period from a time point of a voltage level falling point of the liquid-crystal applying signal to a time point of the lowest voltage level point of the liquid-crystal applying signal.

In an embodiment, the rising time may be defined based on the following Equation 1.

$${τ}_{on} = \frac{γ \cdot {d}^{2}}{{ɛ}_{0} Δɛ ( {V}^{2} - {V}_{th}^{2} )} \qquad [ Equation 1 ]$$

In Equation 1, the τₒₙ denotes the rising time, the ∈₀ denotes vacuum permittivity, the Δ∈ denotes a difference of permittivity between a transverse axis and a longitudinal axis of the liquid crystals, v denotes a voltage level of a liquid-crystal driving signal to be applied to the pixel electrode, Vₜₕ denotes a threshold voltage level for driving a pixel of the display panel, γ denotes viscosity of the liquid crystals, and d denotes a cell gap of the liquid crystal layer.

In an embodiment, the falling time may be defined based on the following Equation 2,

$${τ}_{off} = \frac{γ \cdot {d}^{2}}{{ɛ}_{0} Δɛ {V}_{th}^{2}} \qquad [ Equation 2 ]$$

In Equation 2, τ_{off} denotes the falling time, ∈₀ denotes the vacuum permittivity, Δ∈ denotes the difference of permittivity between the transverse axis and the longitudinal axis of the liquid crystals, Vₜₕ denotes the threshold voltage level for driving the pixel, γ denotes the viscosity of the liquid crystals, and d denotes the cell gap of the liquid crystal layer.

In an embodiment, the fabrication method may further include setting voltage level of the liquid-crystal driving signal, which allows the rising time and the falling time to substantially match with each other, as a maximum voltage level of the liquid-crystal driving signal, based on the Equations 1 and 2.

In an embodiment, a difference between the rising time and the falling time may be smaller than or equal to about 10 milliseconds (ms) at the maximum of the liquid-crystal driving signal.

In an embodiment, the liquid-crystal applying signal may have a driving frequency in a range of about zero hertz (0 Hz) to about 60 hertz (Hz).

In an embodiment, the fabrication method may further include, after the providing the control terminal electrode and the common electrode line, providing a gate insulation film to cover the control terminal electrode and the common electrode line, where an opening is defined in the gate insulation film to expose a portion of the common electrode line through the gate insulation film.

In an embodiment, the common electrode may contact to the exposed portion of the common electrode line.

In an embodiment, the fabrication method may further include, after the providing the input terminal electrode and the output terminal electrode, providing an insulation layer to cover the input terminal electrode and the output terminal electrode, where an opening is defined through the insulation layer to expose a portion of the output terminal electrode through the insulation layer.

In an embodiment, the pixel electrode may contact the exposed portion of the output terminal electrode.

In another embodiment of the inventive concept, A liquid crystal display panel includes: a first substrate; a second substrate; and a liquid crystal layer including P-type liquid crystals and disposed between the first substrate and the second substrate, where the first substrate includes: a first insulation plate; a control terminal electrode disposed on the first insulation plate; a common electrode line disposed on the first insulation plate; a common electrode in contact with the common electrode line; a semiconductor pattern disposed on the control terminal electrode to overlap the control terminal electrode when viewed from a top plan view; an input terminal electrode in contact with a part of the semiconductor pattern; an output terminal electrode in contact with another part of the semiconductor pattern and spaced apart from the input terminal electrode; and a pixel electrode in contact with the output terminal electrode and overlapping the common electrode. In such an embodiment, a plurality of slits are defined in the pixel electrode, and the slits has a predetermined orientation angle to substantially match a rising time and a falling time of a liquid-crystal applying signal corresponding to an electric field applied to the liquid crystal layer, with each other.

According to embodiments of the inventive concept, a flickering effect in a P-type liquid crystal display panel is effectively prevented even while the panel is operating in a low frequency, and a response rate of liquid crystals thereof is substantially improved.

### BRIEF DESCRIPTION OF THE DRAWINGS

The above and other features of embodiments of the inventive concept will become readily apparent by reference to the following detailed description when considered in conjunction with the accompanying drawings, in which:

FIG. 1 is an explosively perspective view illustrating a liquid crystal display panel according to an embodiment of the inventive concept;

FIG. 2A is a plan view illustrating a part of a first substrate according to an embodiment of the inventive concept;

FIG. 2B is a sectional view taken along I-I′ of FIG. 2A;

FIG. 3 is a sectional view illustrating a liquid crystal display panel according to an embodiment of the inventive concept;

FIGS. 4A and 4B are an enlarged view illustrating the area R of FIG. 3;

FIG. 5 is a table summarizing directions of applied electric fields, flexoelectric fields, and the total electric fields in areas A to D in FIG. 4B;

FIGS. 6A and 6B schematically illustrate waveforms of variations on electric field levels by frames in the areas A and B;

FIGS. 7A and 7B are tables summarizing simulation results for the rising and falling times of liquid-crystal applying signals when orientation angles of slits are set differently from one another;

FIGS. 8A to 8F are sectional views illustrating a method of fabricating a liquid crystal display panel, according to an embodiment of the inventive concept;

FIG. 9A is a functional block view illustrating a display device according to an embodiment of the inventive concept; and

FIG. 9B is a circuit view illustrating the grey-scale voltage generator of FIG. 9A, according to an embodiment of the inventive concept.

### DETAILED DESCRIPTION

The terms used in the specification are properly adopted in general terminology in consideration of functions available in various embodiments, but these terms may be variable or modifiable depending on requirements or usual practices of the artisans skilled in the art, or appearance of new technology. When the applicant intentionally adopts specific terms in some embodiments, their meanings will be correspondingly described thereat. Accordingly, the terms used in the specification should be construed with reference to substantial meanings of them and contents disclosed throughout the specification, not by simply interpreting their literal senses.

It will be understood that when an element or layer is referred to as being “on” or “connected to” another element or layer, it can be directly on or connected to the other element or layer or intervening elements or layers may be present. In contrast, when an element is referred to as being “directly on,” or “directly connected to” another element or layer, there are no intervening elements or layers present. Like numbers refer to like elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. “Or” means “and/or.” As used herein, the term “and/or” includes any and all combinations of one or more of the associated listed items. It will be further understood that the terms “comprises” and/or “comprising,” or “includes” and/or “including”, when used in this specification, specify the presence of stated features, integers, steps, operations, elements, and/or components, but do not preclude the presence or addition of one or more other features, integers, steps, operations, elements, components, and/or groups thereof

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Although embodiments of the inventive concept will be apparent from embodiments described in detail hereinafter in conjunction with the accompanying drawings, the inventive concept, however, may be embodied in different forms, and should not be understood as being limited only to the illustrated embodiments.

Hereinafter, embodiments of the inventive concept will be described in detail with reference to the accompanying drawings.

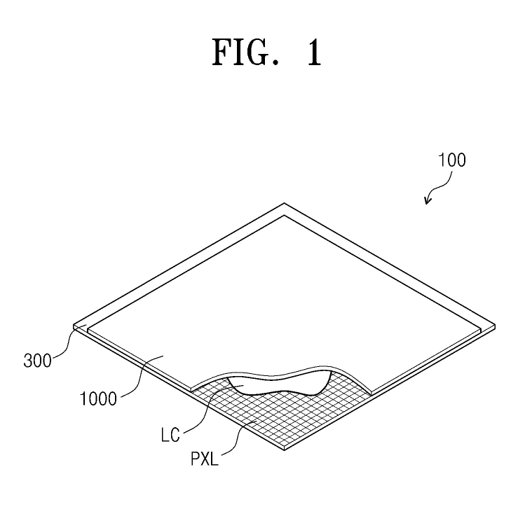

FIG. 1 is an explosively perspective view illustrating a liquid crystal display panel according to an embodiment of the inventive concept.

Referring to FIG. 1, an embodiment of the liquid crystal display panel 100 may a first substrate 300 including a plurality of pixels PXL, a second substrate 1000 opposite to, e.g., facing, the first substrate 300, and a liquid crystal layer LC disposed between the first and second substrates 300 and 1000.

Each pixel PXL of the first substrate 300 may include a thin film transistor, a pixel electrode and a common electrode.

The liquid crystal layer LC may include a plurality of liquid crystal molecules having dielectric anisotropy. The liquid crystal molecules of the liquid crystal layer LC may rotate by an electric field generated between the common electrode and the pixel electrode of the first substrate 300, and thereby adjust transmittance of light that is incident on the liquid crystal layer LC.

The liquid crystal molecules may be classified as one of P-type liquid crystal molecules having permittivity that is larger in longitudinal axis direction than in transverse axis direction, and an N-type liquid crystal molecules having permittivity that is smaller in longitudinal axis direction than in transverse axis direction. N-type liquid crystal molecules are lower than P-type liquid crystal molecules in flicker level during low frequency operation and higher than P-type liquid crystal molecules in transmittance and contrast ratio. Accordingly, the liquid crystal display panel 100 may be fabricated using such N-type liquid crystal molecules.

However, N-type liquid crystal molecules are slower than P-type liquid crystal molecules in response rate. Therefore, embodiments of the inventive concept are directed to a fabrication method of the liquid crystal display panel 100 using P-type liquid crystal molecules which respond with a relatively high rate, namely, a fabrication method of a P-type liquid crystal display panel capable of minimizing a flickering effect that may occur when the panel is operating in a low frequency. Hereinafter, embodiments where the liquid crystal molecules are P-type liquid crystal molecules, and the liquid crystal display panel 100 is a P-type liquid crystal display panel, will be described in detail.

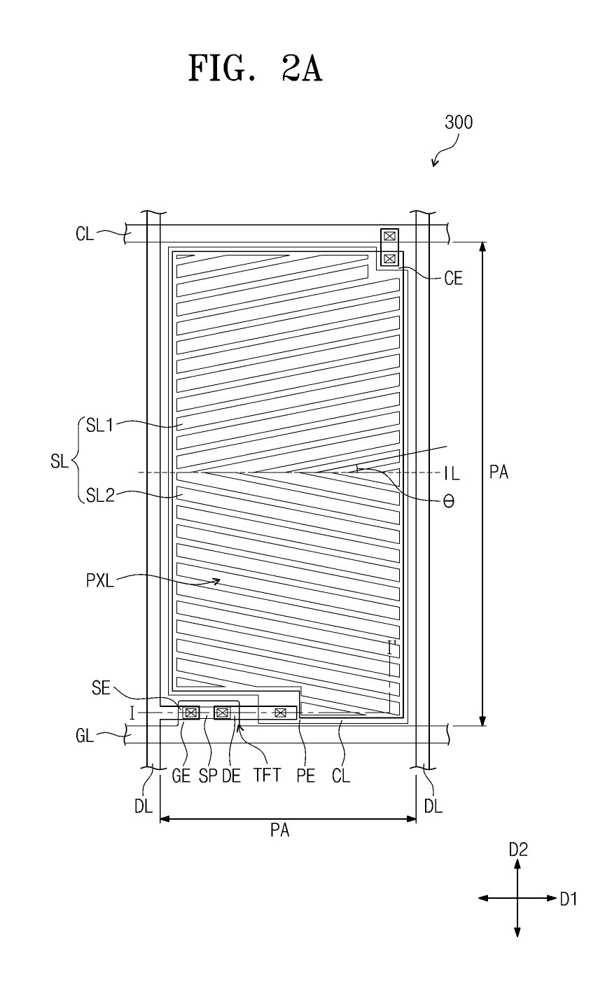

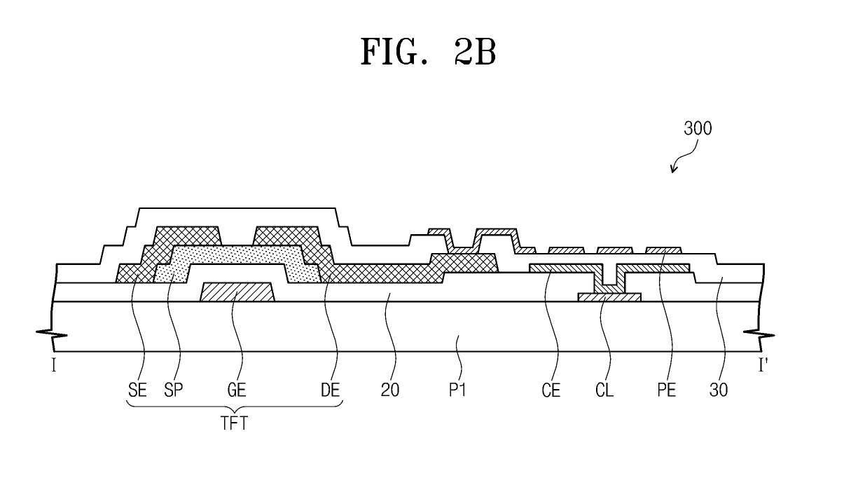

FIG. 2A is a plan view illustrating a part of a first substrate according to an embodiment of the inventive concept. FIG. 2B is a sectional view taken along I-I′ of FIG. 2A.

Referring to FIGS. 2A and 2B, in an embodiment, the first substrate 300 may include a first insulation plate P1 having a plurality of pixel areas PA defined therein, a plurality of gate lines GL, a plurality of data lines DL, a plurality of common electrode lines CL, and a plurality of pixels PXL. For illustrative and descriptive convenience, the drawings show only one pixel of the plurality of pixels PXL. The features of the plurality of pixels are substantially the same as each other. Accordingly, the one pixel PXL shown in the drawings will hereinafter be described in detail, and any repetitive detailed description of other pixels in the liquid crystal display panel 100 will be omitted or simplified.

The first insulation plate P1 may include a transparent insulation material. In an embodiment, a plurality of pixel area PA may be defined in various patterns on the first insulation plate P1. In one embodiment, for example, the plurality of pixel areas PA may be substantially in a matrix form on the first insulation substrate P1.

The gate lines GL may extend in a first direction D1 on the first insulation plate P1. The common electrode lines CL may extend in a direction substantially parallel to the first direction D1 and isolated or spaced apart from the gate lines GL in a second direction D2 intersecting the first direction D1. The data lines DL may extend along the second direction D2.

The gate lines GL and the common electrode lines CL may be arranged on the same layer as each other. A gate insulation film 20 may be interposed between the data lines DL and the gate lines GL. The data lines DL and the gate lines GL may be spaced apart or insulated from each other by the gate insulation film 20. The gate insulation film 20 may be interposed between the data lines DL and the common electrode lines CL. The data lines DL and the common electrode lines CL may be spaced apart or insulated from each other by the gate insulation film 20.

The pixel PXL may be in a corresponding pixel area of the pixel areas PA. In an embodiment, as shown FIG. 2A, the pixel area PA may be defined by one gate line GL, one data line DL and one common electrode line CL, each of which corresponds thereto. However, the inventive concept may not be restrictive to the embodiment described above. In an alternative embodiment, the pixel area PA may be defined in various ways.

The pixel PXL may include a thin film transistor TFT, a pixel electrode PE connected with the thin film transistor TFT, and a common electrode CE.

The thin film transistor TFT may include a control terminal electrode GE, the gate insulation 20, a semiconductor pattern SP, an input terminal electrode SE, and an output terminal electrode DE.

The control terminal electrode GE may be branched out from the gate line GL. The control terminal electrode GE may be disposed on the first insulation plate P1, e.g., a top surface of the first insulation plate P1.

The gate insulation film 20 may be disposed on the control terminal electrode GE to cover the control terminal electrode GE. The gate insulation film 20 may include an organic insulation material or an inorganic insulation material. An opening is defined in through the gate insulation film 20 in a way such that the gate insulation film 20 exposes a part of the common electrode line CL therethrough.

The semiconductor pattern SP may be disposed on the gate insulation film 20. The semiconductor pattern SP may face the control terminal electrode GE, and the gate insulation film 20 may be disposed between the semiconductor patter SP and the control terminal electrode GE. When viewed from a plan view (e.g., a top plan view), the semiconductor pattern SP may overlap the control terminal electrode GE. The semiconductor pattern SP may include a semiconductor oxide, for example, amorphous indium-gallium-zinc-oxide (“a-IGZO”).

The input terminal electrode SE and the output terminal electrode DE may be disposed on the semiconductor pattern SP. The input terminal electrode SE may be branched out from the data line D1. When viewed from a plan view (e.g., a top plan view), the input terminal electrode SE may overlap a portion (e.g., a side portion) of the semiconductor pattern SP. The output terminal electrode DE may be spaced apart from the input terminal electrode SE and overlap another portion (e.g., an opposing side portion) of the semiconductor pattern SP when viewed from a plan view (e.g., a top plan view).

The common electrode CE may be disposed on the same layer with the semiconductor pattern SP. The common electrode CE may be disposed on the gate insulation film 20, and contacts to a portion of the common electrode line CL, which is exposed through the insulation film 20, to make electrical connection with the common electrode line CL. The common electrode CE may be spaced apart from the semiconductor pattern SP and the output terminal electrode DE.

An insulation layer 30 may be disclosed on the input terminal electrode SE, the output terminal electrode DE and the common electrode CE. The insulation layer 30 may include an organic insulation material or an inorganic insulation material. An opening is defined in the insulation layer in a way such that the insulation layer 30 may expose a part of the output node electrode DE therethrough.

The pixel electrode PE may be disposed on the insulation layer 30. At least a part of the pixel electrode PE may overlaps the common electrode CE when viewed from a plan view (e.g., a top plan view), and the insulation layer 30 is interposed between the pixel electrode PE and the common electrode CE. The pixel electrode PE may contact a portion of the output terminal electrode DE, which is exposed through the insulation layer 30, and electrically connected to the output terminal electrode DE.

A plurality of slits SL may be defined in the pixel electrode PE. The slits SL may include upper slits SL1 and lower slits SL2 which are defined with reference to an imaginary line IL crossing the center of the pixel area PA in a transverse direction, e.g., the first direction D1, when viewed from a top view. The upper and lower slits SL1 and SL2 may extend in various patterns. In an embodiment, the upper slits SL1 may extends from the right top toward the left bottom, and the lower slits SL2 may extends from the right bottom toward the left top. However, the inventive concept may not be restrictive to the embodiment described above.

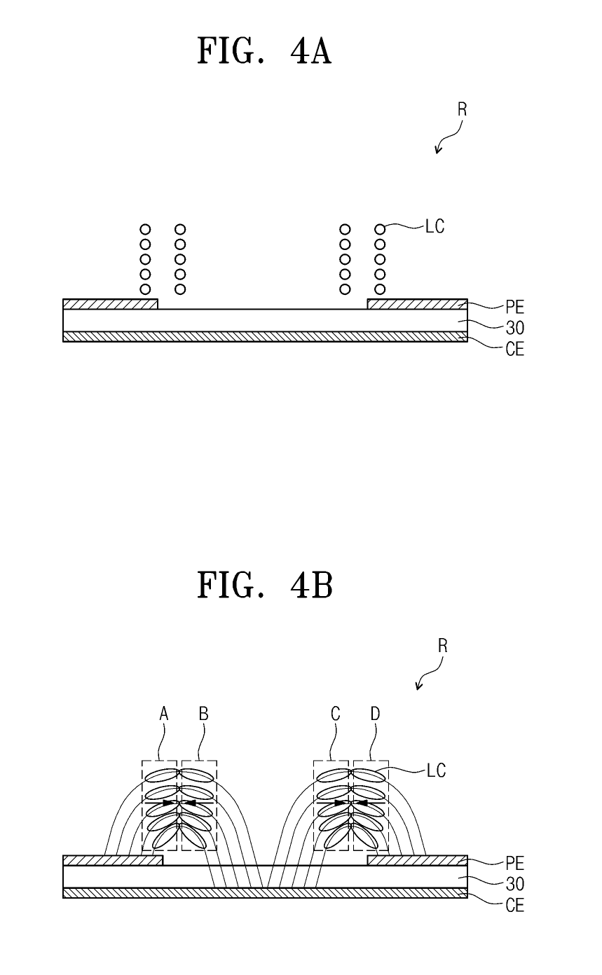

In embodiments, the slits SL may have a constant orientation angle θ. The orientation angle θ may be defined as an angle that formed between the imaginary line IL and the slit SL. The orientation angle θ may be set to a predetermined angle to minimize a flickering effect when the liquid crystal display panel 100 operates in a low frequency, and determined based on a result of simulation. The orientation angle θ will be described later in greater detail with reference to FIGS. 4A to 7B. In such an embodiment, the slits SL may be defined in the pixel electrode PE to have the determined orientation angle θ such that the flickering effect is substantially minimized when the liquid crystal display panel 100 operates in a low frequency.

As described above, in an embodiment, a plurality of the slits SL may be defined in the pixel electrode PE, but not being limited thereto. In an alternative embodiment, the slits SL may be defined any one of the pixel electrode PE and the common electrode CE. The inventive concept may not be restrictive to the aforementioned embodiments.

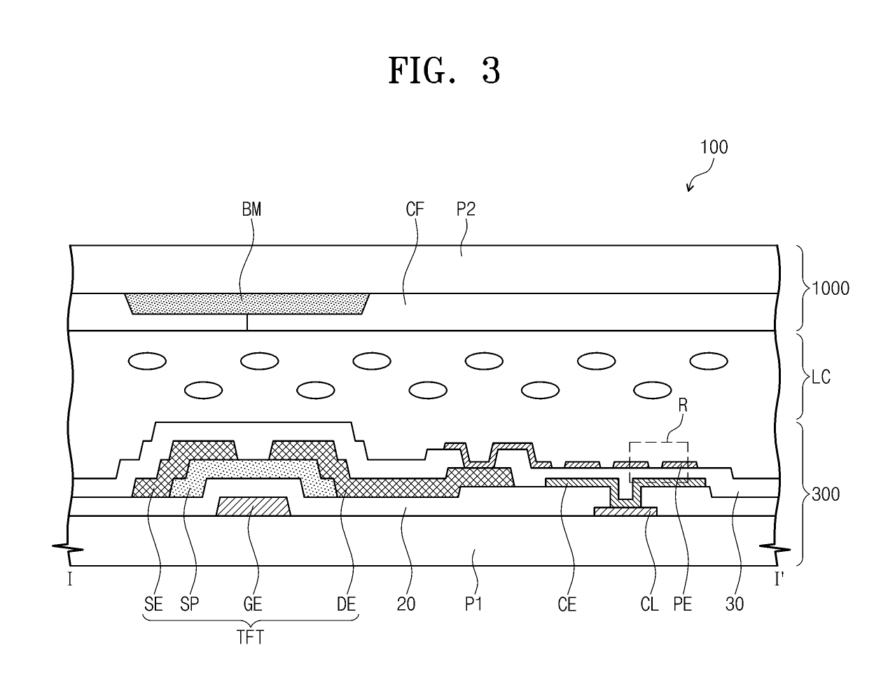

FIG. 3 is a sectional view illustrating a liquid crystal display panel according to an embodiment of the inventive concept.

Referring to FIG. 3, an embodiment of a liquid crystal display panel 100 may include a first substrate 300, a second substrate 1000 disposed opposite to, e.g., facing, the first substrate 300, and a liquid crystal layer LC interposed between the first and second substrates 300 and 1000. The liquid crystal layer LC may include P-type liquid crystal molecules, as described above with reference to FIGS. 2A and 2B.

The second substrate 1000 may include a second insulation plate P2, a black matrix BM disposed on the second insulation plate P2, and color filters CF disposed respectively on areas of the second insulation plate P2, which are exposed or defined by the black matrix BM. The black matrix BM may be disposed substantially in a matrix form on the second substrate 1000. The black matrix BM may overlap a thin film transistor TFT when viewed from a top view.

The color filters CF may be disposed respectively in the areas divided by the black matrix BM. The color filters CF may be classified as one of red, green and blue color filters for representing image colors. The color filters CF may be disposed in various forms. In one embodiment, for example, each of the red, green and blue color filters may have a strip form and extend along a line.

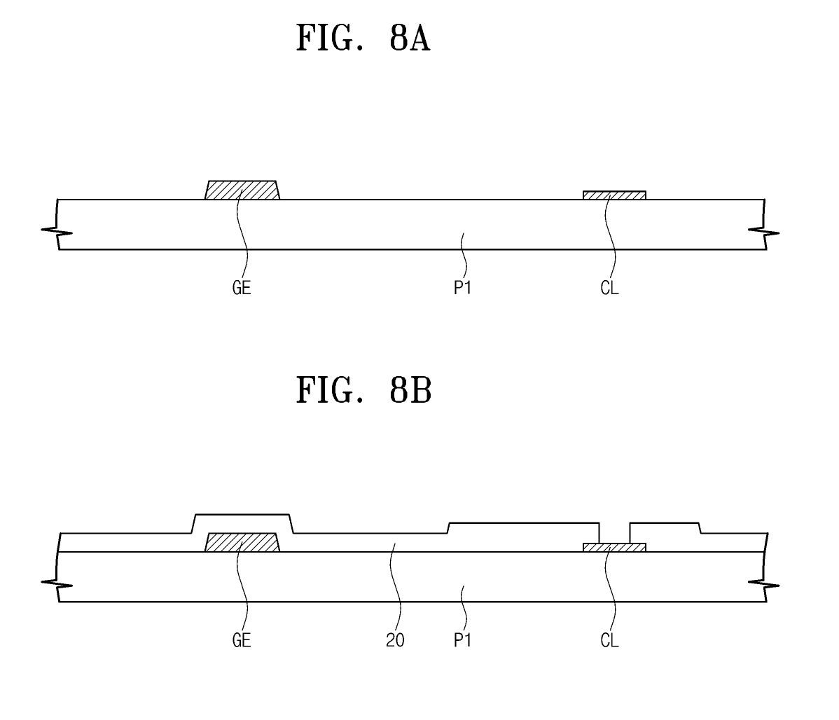

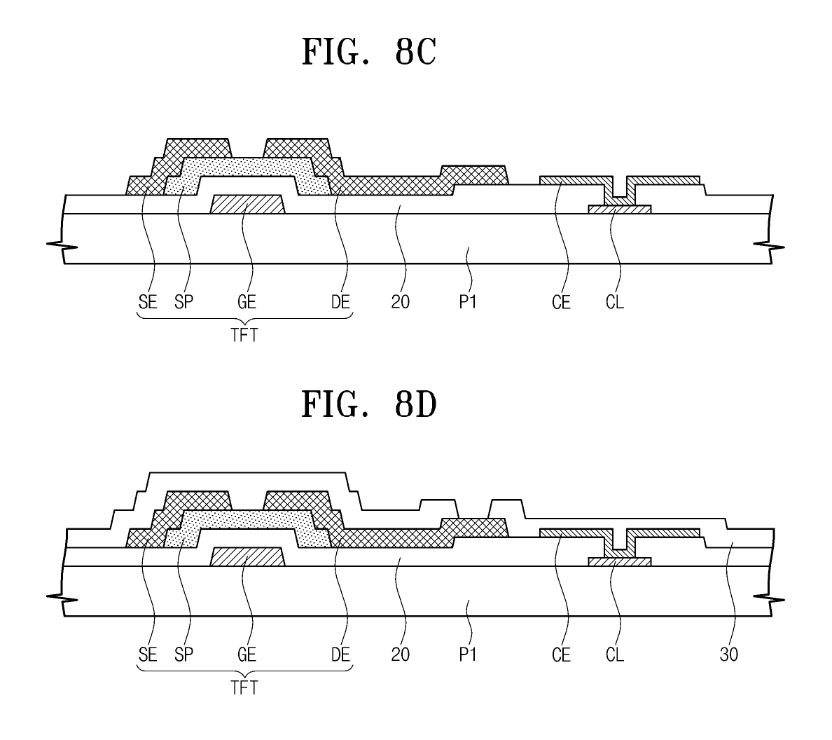

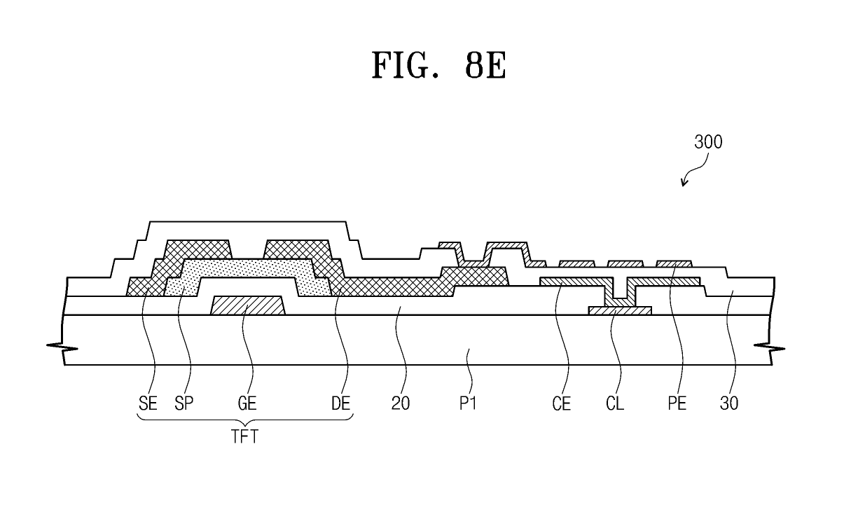

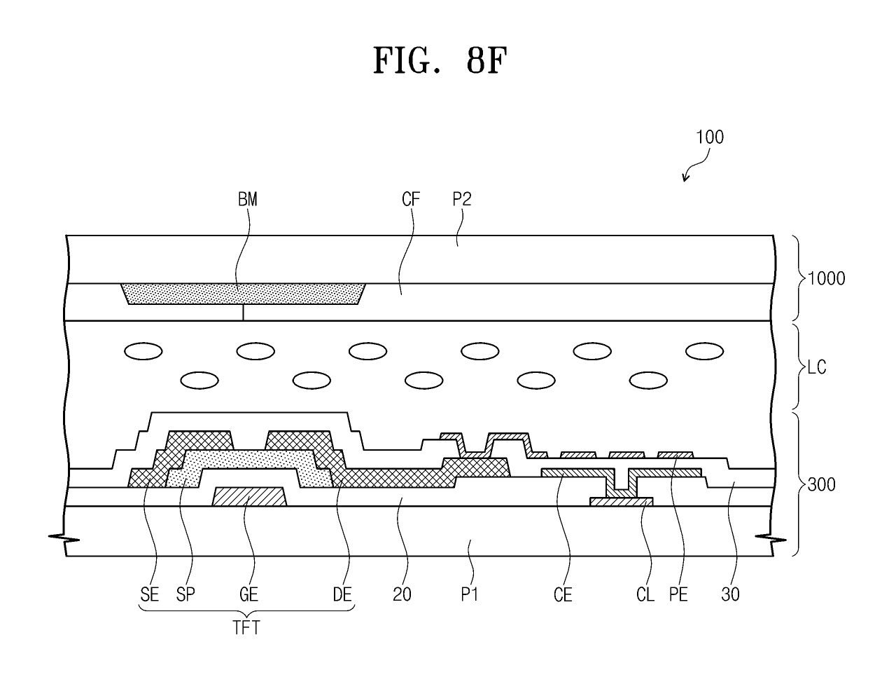

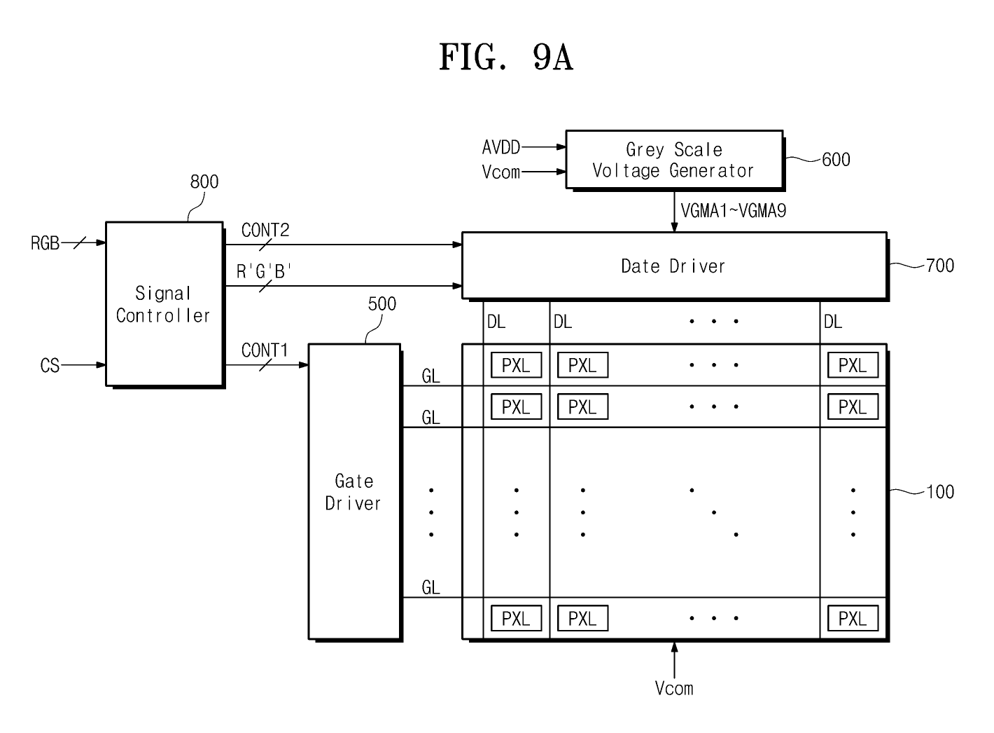

The liquid crystal display panel 100 may be provided or formed by injecting liquid crystal molecules between the first and second substrates 300 and 1000, which are assembled each other, details of which will be described later in greater detail with reference to FIGS. 8A to 8F.

FIGS. 4A and 4B are an enlarged view illustrating the area R of FIG. 3. FIG. 4A illustrates an orientation state of the liquid crystal molecules when no electric field is applied to the liquid crystal layer LC, and FIG. 4B illustrates an orientation state of the liquid crystal molecules when an electric field is applied to the liquid crystal layer LC.

Referring to FIGS. 4A and 4B, as a liquid crystal driving signal for activating the liquid crystal layer LC is applied to the pixel electrode PE, an electric field (hereinafter, referred to as liquid-crystal driving electric field′) may be applied to the liquid crystal layer LC. The liquid crystal molecules may be oriented in a homogeneous pattern when s no electric field is applied thereto, and turn to a splay pattern when a liquid crystal electric field is applied thereto. The splay orientation may increase the magnitude of a flexoelectric field that acts among the liquid crystal molecules. As a result, a level of the total electric field (hereinafter, referred to liquid-crystal applying electric field′) applied to the liquid crystal layer LC may decrease to be lower or increase to be higher than a level of the liquid-crystal driving electric field due to the flexoelectric field.

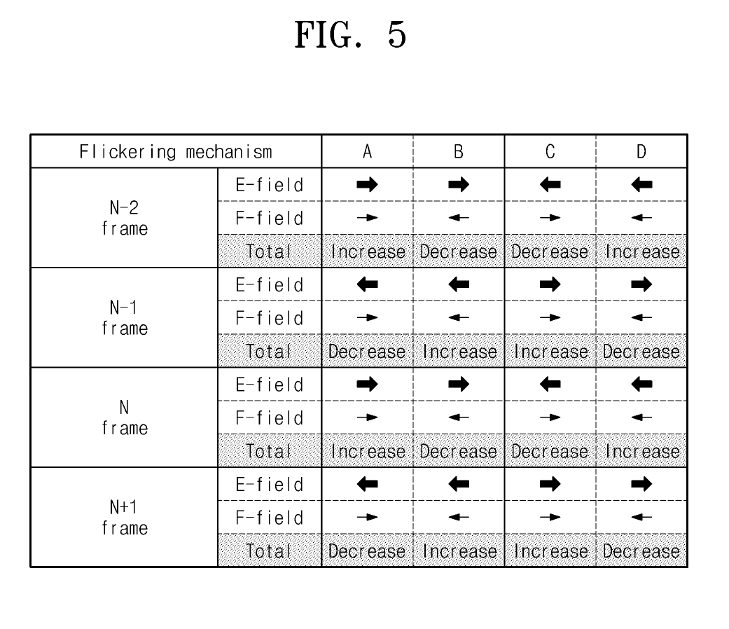

FIG. 5 is a table summarizing directions of applied electric fields, flexoelectric fields, and the total electric fields in the areas A to D in FIG. 4B.

Referring to FIG. 5, if the liquid crystal driving signal is inversed in polarity by the unit of frame (e.g., every frame), the direction of the liquid-crystal driving electric field may be reversed by about 180° in the unit of frame throughout the areas A to D. Since the flexoelectric field is an electric field generated according to a splay orientation of the liquid crystal molecules, an orientation of the flexoelectric field may be arranged uniformly regardless of the polarity inversion. In this case, as shown in FIG. 5, the magnitude (or strength) of the liquid-crystal driving electric field may be larger than the magnitude (or strength) of the flexoelectric field. As a result, while an orientation of the liquid-crystal applying electric field, which is a sum of the liquid-crystal driving electric field and the flexoelectric field, is uniform, the magnitude of the liquid-crystal applying electric field may decrease or increase.

In one embodiment, for example, due to the polarity inversion, the liquid-crystal driving electric field may be oriented toward right in an N−2 frame, left in an N−1 frame, right in an N frame, and left in an N+1 frame. In such an embodiment, due to a splay orientation of the liquid crystal molecules, the flexoelectric field formed in the area A may be all oriented toward left in the N−2−N+1 frames. As a result, an orientation of the liquid-crystal applying electric field in the area A is uniformed in right, but the magnitude of the liquid-crystal applying electric field may decrease or increase by the flexoelectric field.

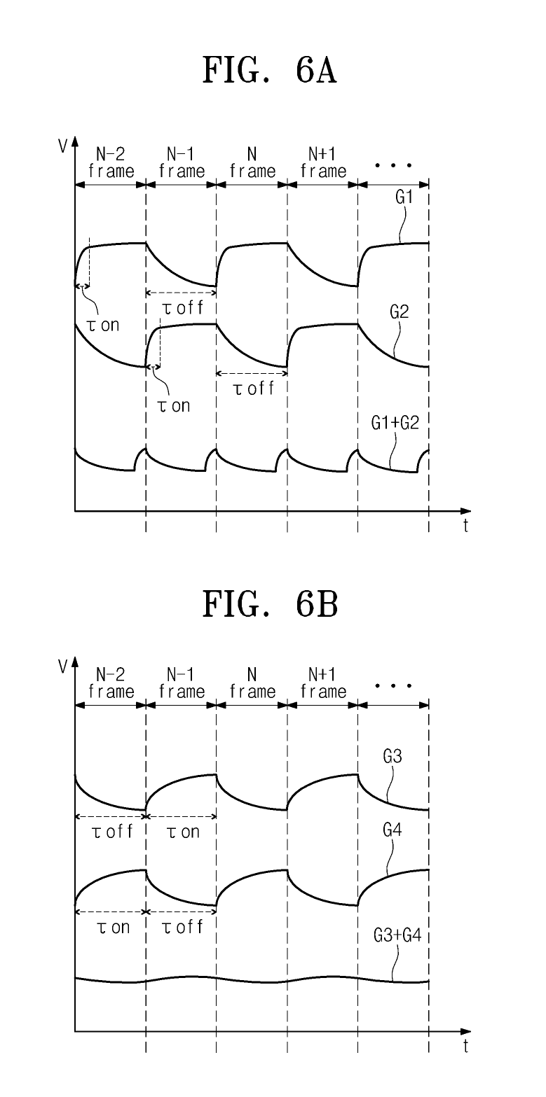

Similarly, in the areas B-D, the flexoelectric field allows the liquid-crystal applying electric field to be uniformly oriented in the unit of frame, but the magnitude of the liquid-crystal applying electric field may decrease or increase. As a viewer recognizes the areas A-D coincidently, level differences of the liquid-crystal applying electric fields in the areas A-D may result in a flickering effect that degrades display quality of the liquid crystal display device. Such a flickering effect will be hereinafter described in greater detail with reference to FIGS. 6A and 6B.

FIGS. 6A and 6B schematically illustrate waveforms of variations on magnitudes of electric field (also, referred to as electric field levels) by frames in the areas A and B.

Referring first to FIG. 6A, a first waveform G1 shows a variation of the liquid-crystal applying electric field (e.g., the electric field applied to the liquid crystals) in each frame at the area A in the form of the liquid-crystal applying signal corresponding to the liquid-crystal applying electric field, a second waveform G2 shows a variation of the liquid-crystal applying electric field in each frame at the area B in the form of the liquid-crystal applying signal, and a third waveform G1+G2 is a combined waveform, which is a combination of the first and second waveforms G1 and G2, in each frame.

As shown in the first and second waveforms G1 and G2, for each liquid-crystal applying signal, a rising time τon may be shorter than a falling time τoff. Herein, the rising time τon may indicate a time period from a time point of a voltage level rising point of the liquid-crystal applying signal to a time point of the highest voltage level point thereof, in each area corresponding to the areas A-D. The falling time τoff may indicate a time period from a time point of a voltage level falling point of the liquid-crystal applying signal from a time point of the lowest voltage level point thereof, in each area corresponding to the areas A-D. A difference between the rising time τon and the falling time τoff, as aforementioned in conjunction with FIG. 5, may be generated due to a level or magnitude variation of the liquid-crystal applying electric field in each frame due to the flexoelectric field.

The difference between the rising time τon and the falling time τoff may cause the third waveform G1+G2, acquired by combining the first and second waveforms G1 and G2, to oscillate without uniformity. As a viewer recognizes the areas A and B coincidently, the viewer may recognize a flickering effect by oscillation of the third waveform G1+G2. Especially, during a low frequency driving mode when a liquid-crystal driving signal with a frequency higher than about zero hertz (0 Hz) and lower than or equal to about 60 hertz (Hz) is applied to the pixel electrode PE, a flickering effect may be further recognized on a viewer.

Accordingly, in an embodiment of the inventive concept, the rising time τon and the falling time τoff are set to match with each other in the same rate to effectively prevent a flicking effect by minimizing an influence from such a flexoelectric field.

Referring to FIG. 6B, a fourth waveform G3 denotes a voltage level variation of a liquid-crystal applying electric field in each frame at the area A in a pattern of the liquid-crystal applying electric field, a fifth waveform G4 denotes a voltage level variation of a liquid-crystal applying electric field in each frame at the area B in a pattern of the liquid-crystal applying electric field, and a sixth waveform G3+G4 is a combined waveform which is a combination of the fourth and fifth waveforms G3 and G4. In an embodiment, as shown by the fourth and fifth waveforms G3 and G4 of FIG. 6B, the rising time τon may be substantially equal to the falling time τoff in each liquid-crystal applying signal. As shown in FIG. 6B, the sixth waveform acquired by combining the fourth and fifth waveforms G3 and G4, may be uniformly maintained without oscillation.

In an embodiment of the inventive concept, an orientation angle θ and the highest voltage level of the liquid-crystal driving signal is determined or preset to substantially match the rising time τon and the falling time τoff each other, details of which will be described hereinafter.

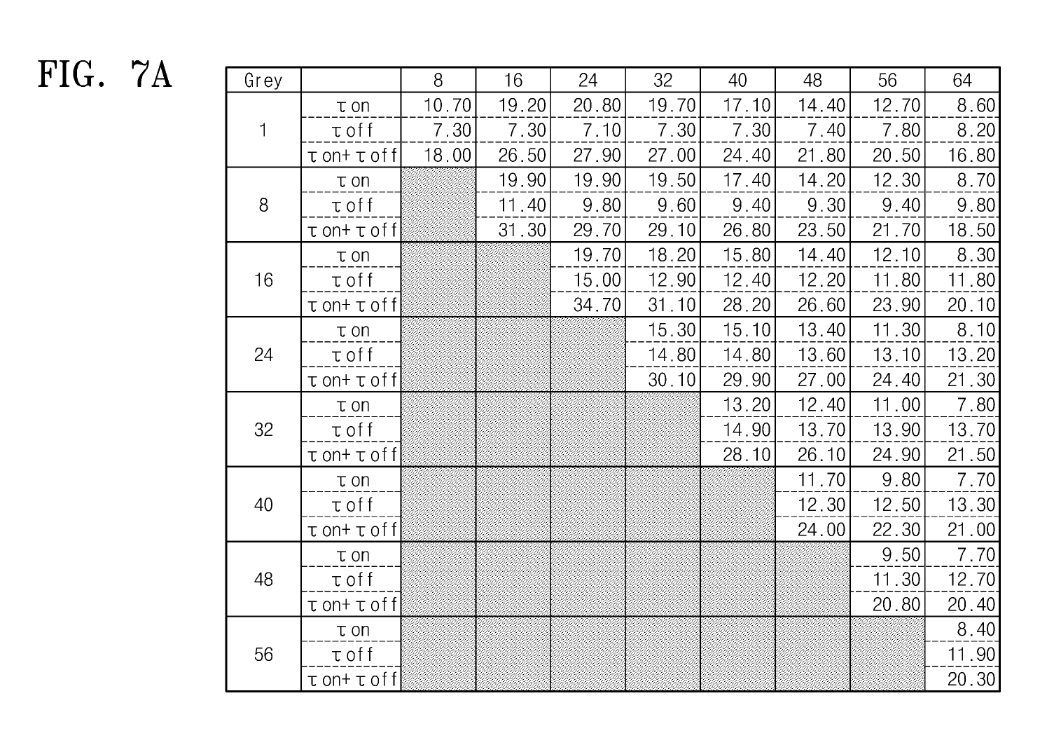

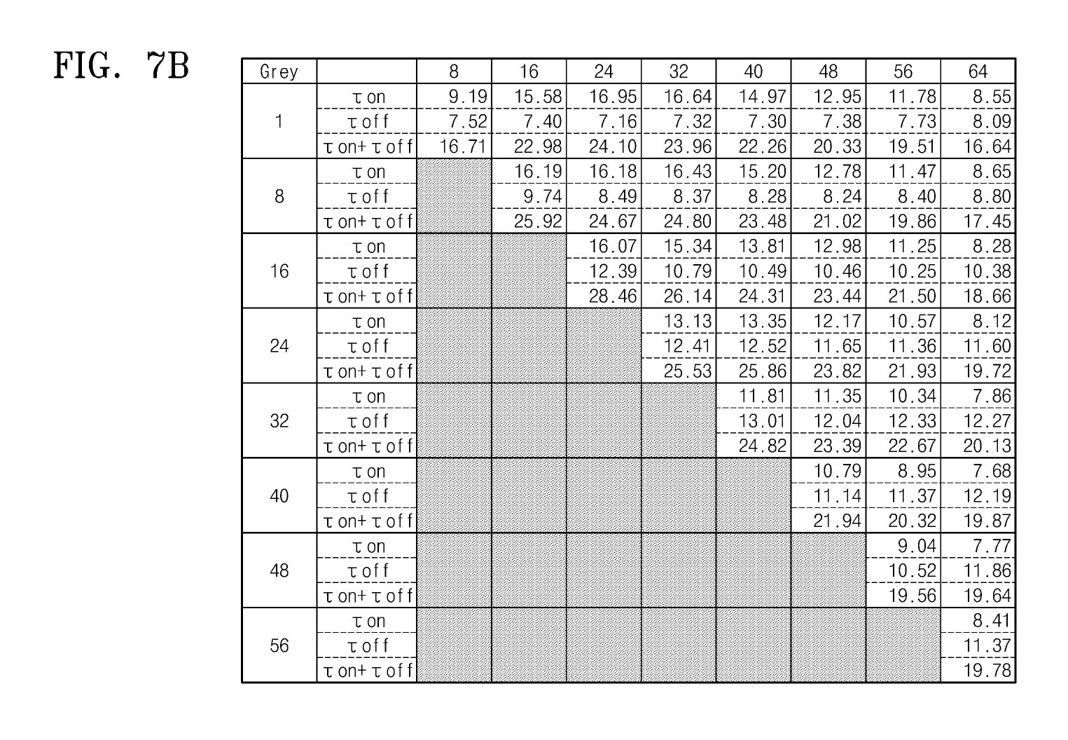

FIGS. 7A and 7B are tables summarizing simulation results for the rising and falling times of liquid-crystal applying signals when orientation angles of slits of the pixel electrode PE or the common electrode CE are set differently from one another. In the simulation relevant to FIG. 7A, an orientation angle θ of the slit SL is set to be about 5°. In the simulation relevant to FIG. 7B, an orientation angle θ of the slit SL is set to be about 10°. Other conditions except the orientation angle θ of the slit SL are the same as each other over the simulations of FIGS. 7A and 7B.

Referring to FIGS. 7A and 7B, if an orientation angle θ of the slit SL increases from about 5° to about 10°, differences between rising times τon and falling times τoff may be substantially reduced except several frames. As shown in FIGS. 7A and 7B, as the orientation angle θ of the slit SL increases, a degree of matching the rising times τon and the falling times τoff may increase overall. Additionally, as the orientation angle θ of the slit SL increases, the rising times τon and the falling times τoff may decrease overall.

In the simulation where the orientation angle θ of the slit SL were set to be about 5°, the rising time τon increasing from Grey 16 to Grey 64 is about 8.3 milliseconds (ms) and the falling time τoff decreasing from Grey 64 to Grey 16 is about 11.80 ms. In the simulation where the orientation angle θ of the slit SL is set to be about 10°, the rising time τon increasing from Grey 16 to Grey 64 is about 8.28 ms and the falling time τoff decreasing from Grey 64 to Grey 16 is about 10.38 ms.

As the orientation angle θ of the slit SL increased from about 5° to about 10°, that the difference between the rising time τon and the falling time τoff may be reduced to about 2.1 ms from about 3.5 ms. Additionally, as the orientation angle θ of the slit SL increased from about 5° to about 10°, the rising time τon and the falling time τoff may be all reduced thereby.

This result is because the orientation angle θ of the slit SL affects a driving rate of the liquid crystal layer LC. Accordingly, before providing the slits SL, the orientation angle θ of the slit SL may be determined to allow the rising time τon to match the falling time τoff to the highest coincidence, and the slits SL may be provided based on the determined orientation angle θ.

In an embodiment, the orientation angle θ of the slit SL may be determined based on a result of the simulation, e.g., in a range of about 10° to about 15°. In such an embodiment, where the orientation angle θ of the slit SL is the range of about 10° to about 15°, the difference between the rising time τon and the falling time τoff may be maintained in a of about zero millisecond (0 ms) to about 10 ms.

FIGS. 8A to 8F are sectional views illustrating a method of fabricating a liquid crystal display panel, according to an embodiment of the inventive concept. The processes shown in FIGS. 8A to 8F may be sequentially performed in fabricating the liquid crystal display panel 100, but not being limited thereto. In an alternative embodiment, the order of the process may be modified, provided with additional steps, or performed without specific steps.

Referring to FIG. 8A, a gate line pattern may be provided using or formed with a first conductive material on a first insulation plate P1, which includes or is formed of a transparent insulation material. The gate line pattern may include a control terminal electrode GE, a gate line (not shown), a common electrode line CL. The gate line pattern may be provided or formed by depositing the first conductive material on the overall surface of the first insulation plate P1 to provide a first conductive film and patterning the first conductive film through a photolithography process with a mask.

The first conductive material may include a metal including at least one selected from copper (Cu), molybdenum (Mo), aluminum (Al), tungsten (W), and chromium (Cr), for example, but not being limited thereto. The first conductive film may include or be formed of a single film, a multiple film, or an alloy film, which include the first conductive material. In one embodiment, for example, the first conductive film may be a triple film of molybdenum-aluminum-molybdenum (Mo—Al—Mo), or a molybdenum-aluminum alloy film.

Then, referring to FIG. 8B, a gate insulation film 20 may be provided or formed on the overall surface of the first insulation plate P1 where the gate line pattern is provided. The gate insulation film 20 may cover the gate line pattern overall, but may be formed to partly expose the common electrode line CL through the gate insulation film 20. Accordingly, the rest of the gate line pattern, except an exposed part of the common electrode line CL, may be insulated from other conductive films to be provided thereon.

Next, referring to FIG. 8C, a semiconductor pattern SP and a common electrode CE may be provided or formed on the gate insulation film 20. The semiconductor pattern SP may be formed to overlap the control terminal electrode GE when viewed from a top view, and the common electrode CE may be formed to overlap the common electrode line CL when viewed from a top view. The semiconductor pattern SP and the common electrode CE may be spaced apart from each other. In one embodiment, for example, the semiconductor pattern SP and the common electrode CE may include or be formed of an amorphous indium-gallium-zinc alloy. The common electrode CE may be formed to contact with the exposed part of the common electrode line CL, which is exposed through the gate insulation film 20, and electrically connected with the common electrode line CL.

Additionally, a data line pattern is formed with or provided using a second conductive material on the first insulation plate P1 where the semiconductor pattern SP and the common electrode CE are provided. The data line pattern may include a data line (not shown), an input terminal electrode (SE), and an output terminal electrode (DE). The data line pattern may be formed by depositing the second conductive material on the overall surface of the first insulation plate P1 to form a second conductive film, and patterning the second conductive film through a photolithography process with a mask. When patterning the second conductive film to provide the data line pattern, the input terminal electrode SE may be patterned to contact with a part of the semiconductor pattern SP and the output terminal electrode DE may be patterned to contact with a part of the semiconductor pattern SP.

The second conductive material may include a metal including at least one selected from copper (Cu), molybdenum (Mo), aluminum (Al), tungsten (W), and chromium (Cr), for example, and the second conductive film may include or be formed of a single film, a multiple film, or an alloy film, which include the second conductive material. In one embodiment, for example, the second conductive film may be a triple film of molybdenum-aluminum-molybdenum (Mo—Al—Mo), or a molybdenum-aluminum alloy film.

Then, referring to FIG. 8D, an insulation material may be provided, e.g., deposited, on the overall surface of the first insulation plate P1 on which the data line pattern is provided. The insulation material may include an organic insulation material or an inorganic insulation material, or may define a single film or a multiple film. Subsequently, the insulation material may be patterned through a photolithography process with a mask to form an insulation layer 30. During such a patterning, the insulation layer 30 may be formed to expose a part of the output terminal electrode DE.

Then, referring to FIG. 8E, a pixel electrode PE including a plurality of slits SL may be provided or formed on the insulation layer 30. The slits SL may be formed to have a uniform orientation angle θ. The orientation angle θ may be determined to minimize an effect of the flexoelectric field. Accordingly, before forming the pixel electrode PE, the orientation angle θ of the slit SL may be determined through a simulation, as described above in conjunction with FIGS. 7A and 7B.

At least a part of the pixel electrode PE may overlap the common electrode CE when viewed from a top view. In such an embodiment, the pixel electrode PE may be electrically connected to the exposed part of the output terminal electrode DE which is exposed through the insulation layer 30.

Next, referring to FIG. 8F, a first substrate 300 including the pixel electrode PE may be combined or assembled with a second substrate 1000. Liquid crystals or liquid crystal molecules are injected between the first and second substrates 300 and 1000 to form a liquid crystal layer LC. The liquid crystal layer LC and the second substrate 1000 are substantially the same as those described above in conjunction with FIGS. 1 to 3.

Hereinafter, an embodiment of determining the maximum voltage level of the liquid-crystal driving signal for minimizing an effect of the flexoelectric field, when the liquid crystal display panel 100 is being driven in a low frequency, will be described below.

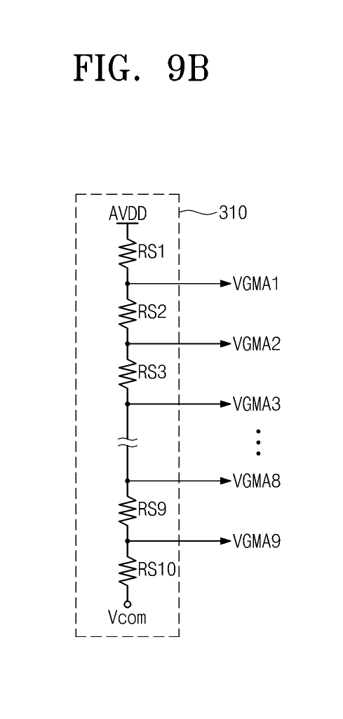

FIG. 9A is a functional block view illustrating a display device according to an embodiment of the inventive concept. The display device according to this embodiment may include the liquid crystal display panel 100, which may be fabricated through the method described above with reference to FIGS. 8A to 8F.

Referring to FIG. 9A, an embodiment of the display device may include a liquid crystal display panel 100, a signal controller 800, a gate driver 500, a grey-scale voltage generator 600, and a data driver 700. The liquid crystal display panel 100 may be the same as that described above in conjunction with FIGS. 1 to 8F, and any repetitive detailed description thereof will be omitted.

The liquid crystal display panel 100 may be manufactured by the method described above with reference to FIGS. 8A to 8F. The liquid crystal display panel 100 may include a plurality of gate lines GL, a plurality of data lines DL, and a plurality of pixels PXL. The gate lines GL and the data lines DL may be insulated from each other and disposed to intersect each other on the liquid crystal display panel 100.

The gate lines GL and the data lines DL may define pixel areas PA. The gate lines GL may be electrically connected with the gate driver 500 and the data lines DL may be electrically connected with the data driver 700. The pixels PXL are disposed respectively in the pixel areas PA, and each of the pixels PXL may be connected to a corresponding data line of the gate lines GL and a corresponding data line of the data lines DL.

The signal controller 800 may receive input image data RGB and convert the input image data RGB into image data R′G′B′ adaptable to an operation of the liquid crystal display panel 100. In such an embodiment, the signal controller 800 may receive control signals CS, for example, a vertical sync signal, a horizontal sync signal, a main clock signal and a data enable signal, and then output a first control signal CONT1 and a second control signal CONT2 based on the control signals CS.

The first control signal CONT1 may include a vertical start signal to start an operation of the gate driver 500, a gate clock signal to determine an output timing of a gate voltage, and an output enable signal to determine an on-pulse width of the gate voltage. The second control signal CONT2 may include a horizontal start signal to start an operation of the data driver 700, a polarity control signal to control a polarity of a liquid-crystal driving signal, and an output start signal to determine an output timing of the liquid-crystal driving signal.

The gate driver 500 may sequentially output gate signals to the gate lines GL in response to the first control signal CONT1. The gate signals may turn on the pixels PXL in the unit of pixel row.

The grey-scale voltage generator 600 may use the maximum and minimum voltage levels of the liquid-crystal driving signal, which operates to drive the liquid crystal display panel 100, to generate reference grey-scale voltages VGMA1-VGMA9 which are involved in optical transmittance of the pixels PXL. The maximum voltage level of the liquid-crystal driving signal may be set to minimize the flexoelectric field of the liquid crystal molecules.

A rising time τon of the liquid-crystal applying signal, which is applied to the liquid crystal layer LC may be obtained from Equation 1 as follows.

$${τ}_{on} = \frac{γ \cdot {d}^{2}}{{ɛ}_{0} Δɛ ( {V}^{2} - {V}_{th}^{2} )} \qquad [ Equation 1 ]$$

In Equation 1, ∈ₒₙ denotes a rising time, ∈₀ denotes vacuum permittivity, Δ∈ denotes a difference of permittivity between the transverse axis and the longitudinal axis of liquid crystals, v denotes a voltage level of the liquid-crystal driving signal to be applied to the pixel electrode PE, Vₜₕ denotes a threshold voltage level for driving a pixel, γ denotes viscosity of liquid crystals, and d denotes a cell gap of the liquid crystal layer LC.

A falling time τoff of the liquid-crystal applying signal may be obtained from Equation 2 as follows.

$${τ}_{off} = \frac{γ \cdot {d}^{2}}{{ɛ}_{0} Δɛ {V}_{th}^{2}} \qquad [ Equation 2 ]$$

In Equation 2, τ_{off} denotes a falling time, ∈₀ denotes vacuum permittivity, Δ∈ denotes a difference of permittivity between the transverse axis and the longitudinal axis of liquid crystals, Vₜₕ denotes a threshold voltage level for driving a pixel, γ denotes viscosity of liquid crystals, and d denotes a cell gap of the liquid crystal layer LC.

Equation 1 may additionally include the factor that is a voltage level of the liquid-crystal driving signal. Accordingly, a voltage level of the liquid-crystal driving signal may be computed to substantially match the rising time τon and the falling time τoff with each other through the Equations 1 and 2.

Therefore, by counting factors, which are derived from the liquid crystal display panel 100 including the slits SL having a specific orientation angle θ, into Equations 1 and 2, a voltage level of the liquid-crystal driving signal may be computed. Such a voltage level of the liquid-crystal driving signal may be set as the maximum voltage level AVDD of the liquid-crystal driving signal which is used for generating the reference grey-scale voltages VGMA1-VGMA9 from the grey-scale voltage generator 600. A computing the maximum voltage level AVDD of the liquid-crystal driving signal may not be defined in a method of fabricating the liquid crystal display panel 100. In an alternative embodiment, the maximum voltage level AVDD of the liquid-crystal driving signal may be computed while the display device is being fabricated or while the liquid crystal display panel 100 is being driven. Equations 1 and 2 may be stored in a form of algorithm and used for computing the maximum voltage level AVDD of the liquid-crystal driving signal.

The grey-scale voltage generator 600 may generate the reference grey-scale voltages VGMA1-VGMA9 from the maximum voltage level AVDD which is set as described above, details of which will be described below in conjunction with FIG. 9B.

The data driver 700 may receive the second control signal CONT2 and the image data R′G′B′. The data driver 700 may convert the image data R′G′B′ into the liquid-crystal driving signals to be provided to the data lines DL. The liquid-crystal driving signals may be generated from the reference grey-scale voltages which are generated by the grey-scale voltage generator 600.

Although not shown, the display device may further include a backlight unit to provide light to the liquid crystal display panel 100, and a pair of polarized plates.

FIG. 9B is a circuit view illustrating the grey-scale voltage generator of FIG. 9A, according to an embodiment of the inventive concept.

Referring to FIG. 9B, a circuit 310 of the grey-scale voltage generator 600 may include a plurality of resistors RS1-RS10 serially connected between the maximum voltage level AVDD and the minimum voltage level Vcom of the liquid-crystal driving signal. The minimum voltage level Vcom may be identical to a voltage level to be applied to the common electrode CE, or the ground voltage level. The reference grey-scale voltages VGMA1-VGMA9 may be generated based on voltage division between the maximum voltage level AVDD and the minimum voltage level Vcom. The reference grey-scale voltages VGMA1-VGMA9 may be used in generating the liquid-crystal driving signals for driving the pixels PXL.

While the embodiments of the inventive concept are described in conjunction with several drawings which are properly sectored, it may be allowable to combine two or more embodiments of the drawings to implement other embodiments. Additionally, the liquid crystal display panel and the display device may not be simply applicable with the configurations and methods aforementioned in connection with the embodiments, rather the embodiments may be even partly or entirely selected and configured in combination for various modifications.

Additionally, while some embodiments of the inventive concept are illustratively described above, the invention may not be restrictive to the aforementioned specific embodiments. Moreover, it may be permissible for the invention to be variously modified by those skilled in the art within the substance set force in the annexed claims and the equivalents. Therefore, those modifications may not be construed as being separated from the technical ideas or outlooks of the inventive concept.

What is claimed is:

1. A fabrication method of a display panel, the fabrication method comprising:
manufacturing a first substrate of the display panel;
providing a second substrate of the display panel to face the first substrate; and
combining the second substrate with the first substrate and providing a liquid crystal layer between the first and second substrates by injecting liquid crystals between the first and second substrates,
wherein the manufacturing the first substrate comprises:
providing a first insulation plate;
providing a control terminal electrode and a common electrode line on the first insulation plate;
providing a common electrode to contact with the common electrode line and providing a semiconductor pattern on the control terminal electrode to overlap each other when viewed from a top plan view;
providing an input terminal electrode to contact with a part of the semiconductor pattern and providing an output terminal electrode to contact with another part of the semiconductor pattern, and to be spaced apart from the input terminal electrode;
determining an orientation angle of a slit to be defined in a pixel electrode to substantially match a rising time and a falling time of a liquid-crystal applying signal corresponding to an electric field applied to the liquid crystal layer, with each other; and
providing the pixel electrode, in which a plurality of slits having the determined orientation angle is defined, to contact with the output terminal electrode.

2. The fabrication method of claim 1, wherein the liquid crystal is a P-type liquid crystal.

3. The fabrication method of claim 2, wherein the providing the pixel electrode comprises providing the pixel electrode to at least partially overlap the common electrode when viewed from the top view.

4. The fabrication method of claim 2, wherein the second substrate comprises:
a second insulation plate;
a black matrix disposed on the second insulation substrate; and
color filters correspondingly disposed in respective areas of the second insulation substrate, which are defined by the black matrix.

5. The fabrication method of claim 2, wherein the orientation angle of the slit is defined as angle formed between an imaginary line, which intersects a center of a pixel of the display panel when viewed from the top plan view, and each of the slits.

6. The fabrication method of claim 5, wherein the orientation angle of the slit is in a range of about 10° to about 15°.

7. The fabrication method of claim 2, wherein
the rising time is defined as a time period from a time point of a voltage level rising point of the liquid-crystal applying signal to a time point of a highest voltage level point of the liquid-crystal applying signal, and
the falling time is defined as a time period from a time point of a voltage level falling point of the liquid-crystal applying signal to a time point of a lowest voltage level point of the liquid-crystal applying signal.

8. The fabrication method of claim 7, wherein the rising time is defined based on Equation 1:
$${τ}_{on} = \frac{γ \cdot {d}^{2}}{{ɛ}_{0} Δɛ ( {V}^{2} - {V}_{th}^{2} )} ,$$
wherein
τₒₙ denotes the rising time,
∈₀ denotes vacuum permittivity,
Δ∈ denotes a difference of permittivity between a transverse axis and a longitudinal axis of the liquid crystals,
v denotes a voltage level of a liquid-crystal driving signal to be applied to the pixel electrode,
Vₜₕ denotes a threshold voltage level for driving a pixel of the display panel,
γ denotes viscosity of the liquid crystals, and
d denotes a cell gap of the liquid crystal layer.

9. The fabrication method of claim 8, wherein the falling time is defined based on Equation 2:
$${τ}_{off} = \frac{γ \cdot {d}^{2}}{{ɛ}_{0} Δɛ {V}_{th}^{2}} ,$$
wherein
τ_{off} denotes the falling time,
∈₀ denotes the vacuum permittivity,
Δ∈ denotes the difference of permittivity between the transverse axis and the
longitudinal axis of the liquid crystals,
Vₜₕ denotes the threshold voltage level for driving the pixel of the display panel,
γ denotes the viscosity of the liquid crystals, and
d denotes the cell gap of the liquid crystal layer.

10. The fabrication method of claim 9, further comprising:
setting voltage level of the liquid-crystal driving signal, which allows the rising time and the falling time to substantially match with each other, as a maximum voltage level of the liquid-crystal driving signal, based on the Equations 1 and 2.

11. The fabrication method of claim 10, wherein a difference between the rising time and the falling time is smaller than or equal to about 10 milliseconds at the maximum of the liquid-crystal driving signal.

12. The fabrication method of claim 2, wherein the liquid-crystal applying signal has a driving frequency in a range of about zero hertz (0 Hz) to about 60 hertz.

13. The fabrication method of claim 2, further comprising:
after the providing the control terminal electrode and the common electrode, line, providing a gate insulation film to cover the control terminal electrode and the common electrode line,
wherein an opening is defined in the gate insulation film to expose a portion of the common electrode line through the gate insulation film.

14. The fabrication method of claim 13, wherein the common electrode contacts the exposed portion of the common electrode line.

15. The fabrication method of claim 2, further comprising:
after the providing the input terminal electrode and the output terminal electrode, providing an insulation layer to cover the input terminal electrode and the output terminal electrode,
wherein an opening is defined through the insulation layer to expose a portion of the output terminal electrode through the insulation layer.

16. The fabrication method of claim 15, wherein the pixel electrode contacts the exposed portion of the output terminal electrode.

17. A liquid crystal display panel comprising:
a first substrate;
a second substrate; and
a liquid crystal layer including P-type liquid crystals and disposed between the first substrate and the second substrate,
wherein the first substrate comprises:
a first insulation plate;
a control terminal electrode disposed on the first insulation plate;
a common electrode line disposed on the first insulation plate;
a common electrode in contact with the common electrode line;
a semiconductor pattern disposed on the control terminal electrode to overlap the control terminal electrode when viewed from a top plan view;
an input terminal electrode in contact with a part of the semiconductor pattern;
an output terminal electrode in contact with another part of the semiconductor pattern and spaced apart from the input terminal electrode; and
a pixel electrode in contact with the output terminal electrode and overlapping the common electrode,
wherein
a plurality of slits are defined in the pixel electrode, and
the slits has a predetermined orientation angle to substantially match a rising time and a falling time of a liquid-crystal applying signal corresponding to an electric field applied to the liquid crystal layer, with each other.

18. The liquid crystal display panel of claim 17, wherein the second substrate comprises:
a second insulation plate;
a black matrix disposed on the second insulation substrate; and
color filters correspondingly disposed in respective areas of the second insulation substrate, which are defined by the black matrix.

19. The fabrication method of claim 17, wherein the orientation angle of the slits is defined as an angle formed between an imaginary line, which intersects a center of a pixel of the liquid crystal display panel when viewed from the top plan view, and each of the slits.

20. The fabrication method of claim 19, wherein the orientation angle of the slit is in a range of about 10° to about 15°.
